(19) United States
(12) Patent Application Publication
(10) Pub. No.: US 2009/0130416 A1
(43) Pub. Date: May 21, 2009

(54) Highly Filled Fibrous Veil

(76) Inventors: Paul A. Geel, Heveadorp (NL); Rene Kosse, Apeldorn (NL); Daphne Haubrich, Apeldorn (NL)

Correspondence Address: OWENS CORNING, 2790 COLUMBUS ROAD, GRANVILLE, OH, 43023, US

(21) Appl. No.: 12/275,595

(22) Filed: Nov. 21, 2008

Related U.S. Application Data
(63) Continuation of application No. 11/485,652, filed on Jul. 13, 2006, now abandoned.
Application No. 11/485,652 is a continuation-in-part of application No. 10/585,538.
(60) Provisional application No. 60/581,008, filed on Jun. 18, 2004.

(51) Int. Cl. B32B 5/02; B29C 39/00

(52) U.S. Cl. 428/220; 442/178; 442/180; 264/212

(57) ABSTRACT

An impregnated fibrous veil comprises a nonwoven fibrous veil including a prebinder and reinforcing fibers. The reinforcing fibers are selected from a group consisting of glass fibers, ceramic fibers and mixtures thereof. The nonwoven fibrous veil has at least one face impregnated with a surface finish formulation. The surface finish formulation includes about 80 to about 98 weight percent filler, about 2 to about 20 weight percent binder and about 0 to about 1 weight percent optical brightener.

This application is a continuation of prior U.S. application Ser. No. 11/485,652 filed on 13 Jul. 2006 and is a continuation-in-part of prior U.S. application Ser. No. 10/585,538 which claims the benefit of U.S. Provisional Patent Application Ser. No. 60/537,677 filed on 20 Jan. 2004 and is the National Stage of International Application Serial No. PCT/US05/18012 which claims priority to U.S. Provisional Patent Application Ser. No. 60/581,008 filed on 18 Jun. 2004.

### TECHNICAL FIELD AND INDUSTRIAL APPLICABILITY OF THE INVENTION

The present invention relates to an impregnated fibrous veil particularly characterized by a high filling degree and to a process for manufacturing that veil.

### BACKGROUND OF THE INVENTION

Fibrous webs or veils of intermingled, randomly oriented reinforcing fibers are well known in the art. Such veils have been used for a number of purposes.

For example, U.S. Pat. No. 6,497,787 to Geel discloses a process for making a microsphere-filled wet-laid veil useful as a lightweight core reinforcement for GRP sandwich panel applications. In this process a formed veil is passed on a belt through a first belt dryer wherein a prebinder is bonded to the nonwoven fibrous veil to form a prebonded nonwoven fibrous veil. An impregnation binder liquid including microspheres is then applied to the prebonded nonwoven fibrous veil and subsequently dried in a second dryer. The microspheres improve the rigidity or impact resistance of articles reinforced with the resulting microsphere-filled wet-laid veil.

The present invention relates to an impregnated veil which may be incorporated into cushion vinyl flooring. Such flooring includes a polyvinyl chloride top layer, a print layer showing the design, a polyvinyl chloride top foam layer, a polyvinyl chloride saturation layer reinforced with the veil of the present invention and a polyvinyl chloride backing layer (usually a foam). The flooring may also include a polyurethane protection layer.

### SUMMARY OF THE INVENTION

An impregnated fibrous veil is disclosed. The impregnated fibrous veil comprises a nonwoven fibrous veil including a prebinder and reinforcing fibers selected from a group consisting of synthetic fibers, glass fibers, ceramic fibers, and mixtures thereof. The nonwoven fibrous veil has at least one face impregnated with a surface finish formulation including about 80 to about 98 weight percent filler, about 2 to about 20 weight percent binder and about 0 to about 1 weight percent optical brightener.

Still more specifically describing the invention the impregnated fibrous veil may be further characterized by an air porosity of about 100 l/m²s to about 2,000 l/m²s at 1 m Bar pressure. The impregnated fibrous veil has a thickness between about 0.3 mm to about 0.7 mm at 0.5 kPa. Additionally, it should be appreciated that microspheres are substantially absent from the surface finish formulation.

The nonwoven fibrous veil includes about 5 to about 20 weight percent prebinder and between about 80 to about 95 weight percent reinforcing fibers. The prebinder is typically selected from a group of materials consisting of a water dispersible binder powder or binder fiber. The prebinder used may include bonding fibers and typically thermoplastic bonding fibers. The prebinder may include bicomponent fibers. The reinforcing fibers have a diameter between about 6.5 and about 16 microns and a length between about 4 and about 33 mm.

The filler utilized in the surface finish formulation is an inorganic filler that is dispersible in water. The inorganic filler has an average particle size in the range of between about 0.1 and 50 microns. The filler may comprise mineral and/or polymer particles. Typically the filler is selected from a group consisting of calcium carbonate, aluminum trihydrate, titanium dioxide, magnesium hydroxide, silicium oxide, clay, talc and mixtures thereof.

The binder utilized in the surface finish formulation may include both thermosetting and thermoplastic resins. Typically the binder is a water dispersible emulsion type binder or a solution type binder. The binder may be selected from a group of materials consisting of polymers and copolymers of styrene, butadiene, acrylic, methacrylic monomers, vinyl acetate as well as polyesters, polyvinyl alcohols, melamin formaldehyde resins, urea formaldehyde resins and any mixtures thereof.

In accordance with yet another aspect of the present invention, a method of producing an impregnated fibrous veil with a smooth surface finish is provided. The method comprises impregnating at least one face of a nonwoven fibrous veil including a prebinder and reinforcing fibers with a surface finish formulation including about 80 to about 98 weight percent filler, about 2 to about 20 weight percent binder and about 0 to about 1 weight percent optical brightener.

The impregnating step includes applying the surface finish formulation to at least one face of the nonwoven fibrous veil at a rate of between about 60 g/m² to about 200 g/m² dry weight. The impregnating step further includes feeding the nonwoven fibrous veil in-line during the applying step. Still further the impregnating step includes drying and consolidating the impregnated fibrous veil following the applying step.

In the following description there is shown and described a preferred embodiment of this invention simply by way of illustration of one of the modes best suited to carry out the invention. As it will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain certain principles of the invention. In the drawings:

FIG. 1 is an edge on elevational view of the impregnated fibrous veil of the present invention; and

FIG. 2 is a schematical representation of the process for making that impregnated fibrous veil.

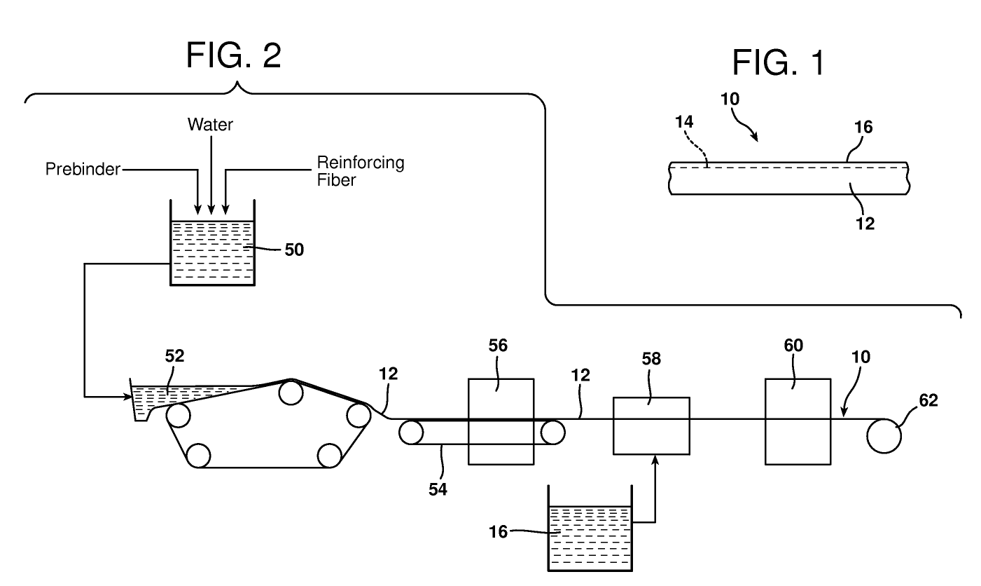

Reference will now be made in detail to the present preferred embodiment of the invention, an example of which is illustrated in the accompanying drawings.

### DETAILED DESCRIPTION AND PREFERRED EMBODIMENTS OF THE INVENTION

The present invention relates to an impregnated fibrous veil 10 including a wet-laid fibrous veil 12 of prebinder and reinforcing fibers having at least one face 14 thereof impregnated with a surface finish formulation 16. That surface finish formulation 16 includes about 80 to about 98 weight percent filler, about 2 to about 20 weight percent binder and about 0 to about 1 weight percent optical brightener.

As used herein, the term “wet-laid fibrous veil” refers to a web of intermingled, randomly oriented reinforcing fibers made according to a wet-laid process. The “veil” of the present invention may also include “sheets” or “mats” made in accordance with the wet-laid process. The fibers are preferably segmented and optionally, the formed veil may be reinforced with continuous filaments.

“Impregnating” or “impregnated” as used herein, refers to a means of integrating fillers into the fibrous veil. The method of impregnating may be conducted by any method suitable for integrating or incorporating these materials into the fibrous veil. In accordance with the present invention, the fillers are impregnated into the veil at any time after formation of the veil. In particular, the fillers are preferably impregnated after formation in a formation chamber, such as on a wire, or after being passed through a first dryer.

As previously noted, the impregnated fibrous veil 10 of the present invention comprises a nonwoven wet-laid fibrous veil 12 including a prebinder and reinforcing fibers selected from a group consisting of glass fibers, ceramic fibers, synthetic fibers and mixtures thereof. More specifically, the nonwoven fibrous veil 12 includes about 5 to about 25 weight percent prebinder and between about 75 to about 95 weight percent reinforcing fibers. More typically, the veil 12 includes about 10 to about 20 weight percent prebinder and between about 80 to about 90 weight percent reinforcing fibers. The prebinder can consist of bonding powder or includes bonding fibers and preferably thermoplastic bonding fibers. The prebinder may also include bicomponent fibers. The reinforcing fibers typically have a diameter between about 6.5 and about 16 microns and a length between about 4 and about 33 mm.

At least one face 14 of the nonwoven fibrous veil 12 is impregnated with a surface finish formulation 16. That surface finish formulation includes about 80 to about 98 weight percent filler, about 2 to about 20 weight percent binder and about 0 to about 1 weight percent optical brightener. Typically the filler is an inorganic or mineral filler and/or polymer particle that is dispersible in water. The average particle size is less than 50 microns and preferably below 30 microns. In order to ensure good surface quality and smoothness, a typical particle size distribution range is from about 0.1 to about 10.0 microns with an average of 5 microns. Fillers useful in the present invention include but are not limited to calcium carbonate, aluminum trihydrate, titanium dioxide, magnesium hydroxide, silicium oxide, clay, talc, recycled glass fibers, recycled glass veil and mixtures thereof.

The binder of the surface finish formulation may include both thermosetting and thermoplastic resins. Typically the binder is a water dispersible emulsion type binder. Alternatively, it may be a solution type binder. Binders useful in the surface finish formulation 16 include but are not limited to polymers and copolymers of styrene, butadiene, acrylic and methacrylic monomers, vinyl acetate as well as polyesters, polyvinyl alcohols, melamin formaldehyde resins, urea formaldehyde reins and any mixtures thereof. The binder may include both a solution type binder and an emulsion type binder provided at a ratio of between about 0.1 to 1 to about 10 to 1. A useful binder is a combination of polyvinyl alcohol and acrylic emulsion at a ratio of about 1 to 2.

The optional optical brightener useful in the surface finish formulation 16 is preferably a water dispersible optical brightener that is not sensitive to degradation due to weathering. Thus, the optical brightener must, for example, be resistant to ultraviolet radiation of the sun. An example of an appropriate optical brightener useful in the highly filled formulation 16 is Leucophor UO as manufactured and sold by Clariant Benelux.

The process of manufacturing the impregnated fibrous veil 10 of the present invention is illustrated in FIG. 2. In the illustrated wet lay process, the prebinder, reinforcing fibers and water are agitated in a mixing tank 50 to provide an aqueous fiber slurry. The reinforcing fibers may be used as filaments or as strands of gathered filaments in chopped form. Optionally, continuous filaments can be used as length-oriented reinforcement for the veil. Additional elements to make up the aqueous slurry may be added as is known in the art. For example, surfactants, anti-foams, viscosity modifier and anti-microbial agents may be provided along with the prebinder into the slurry.

As illustrated in FIG. 2 the aqueous fiber slurry is transferred from the mixing tank 50 onto a suitable forming apparatus 52. The forming apparatus may, for example, take the form of a moving screen or forming wire on an inclined wire forming machine, wire cylinders, Foudrinier machines, Stevens Former, Roto Former, Inver Former or Venti Former machines. Preferably, the formation of the veil 12 is on an inclined wire forming machine. The fibers and the additional slurry elements in the aqueous fiber slurry enmesh themselves into a freshly prepared wet laid fibrous veil 12 on the forming apparatus 52 while excess water is separated therefrom. The dewatering step may be conducted by any known method such as by draining, vacuum, etc. The water content of the veil after dewatering and vacuum is preferably in the range of about 50 to about 85%.

After the wet-laid nonwoven fibrous veil 12 is formed, the veil is transferred to a transport belt 54. The belt 54 carries the veil 12 into a means 56 for substantially removing the water. The removal of water may be conducted by known web drying methods, including the use of a rotary/through air dryer or oven, a heated drum dryer, an infrared heating source, hot air blowers, microwave emitting source and the like. At least one method of drying is necessary for removing the water but a plurality of these methods may be used in combination to remove the water and dry the wet laid fibrous veil 12. The temperature of the dryer may range from about 120 degrees C. at the start until about 210 degrees C. at the end of the first drying process. The air speed may be in the range of about 0.5 to 1 m/s. During drying the prebinder is bound to the reinforcing fibers in order to prebond the veil 12.

The prebonded veil 12 is then impregnated with the highly filled formulation 16 by applying the surface finish formulation at a dry rate of between about 60 g/m² to about 200 g/m². Any method suitable for impregnating at least one face 14 of the prebonded veil 12 may be used. For example, suitable methods include using a size press 58, such as a Foulard applicator, a binder wire, rotary screen, dipping roll, spraying, coating equipment and the like. While other additional agents or coatings may be applied, preferably only the surface finish formulation 16 is contacted with the prebonded veil 12. Following the impregnation of the face 14 of the prebonded veil 12 with the surface finish formulation 16, is the drying and consolidating of the impregnated fibrous veil 10. Thus the now impregnated veil 10 is dried in a second dryer 60 which is preferably an airfloat oven. The resulting dried impregnated fibrous veil 10 is then collected on a winder 62.

The veil 10 of the present invention may be used as a carrier to manufacture cushion vinyl flooring. Advantageously, such flooring incorporating the impregnated fibrous veil 10 of the present invention exhibits a number of beneficial properties including reduced plastisol consumption and improved stiffness. Additionally, the panels provide better environmental durability.

The following examples are presented in order to further illustrate the invention, but is not to be considered as limited thereto.

### EXAMPLE 1

A base veil consisting of 50 gsm weight made of 84% glass fiber and 16% PVA binder is impregnated with 170 gsm binder consisting of ˜95% anorganic powder and ˜5% polymeric binder.

### EXAMPLE 2

A base veil consisting of 35 gsm weight made of 84% glass fiber and 16% PVA binder is impregnated with 125 gsm binder consisting of ˜95% anorganic powder and ˜5% polymeric binder.

### EXAMPLE 3

A base veil consisting of 30 gsm weight made of 84% glass fiber and 16% PVA binder is impregnated with 95 gsm binder consisting of ˜95% anorganic powder and ˜5% polymeric binder.

The impregnated fibrous veil 10 of the present invention is characterized by a unique combination of properties. The veil 10 has an air porosity of between about 100 l/m²s to about 2,000 l/m²s at 1 m Bar pressure. This allows good wet out of the surface veil with resin. Further, the veil 10 has a thickness of about 0.3 mm to about 0.7 mm at 0.5 kPa. The veil 10 is thin but retains good print through hiding power.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, in accordance with the method illustrated in FIG. 2, the prebinder and reinforcing fibers are heat cured prior to application of the surface finish formulation. It should be appreciated, however, that the surface finish formulation may be applied to the nonwoven fibrous veil including the prebinder and reinforcing fibers prior to curing of the prebinder. In this way both the prebinder and surface finish formulation are cured simultaneously during a single heating step.

In addition, while it is preferred that the surface finish formulation is applied inline to the prebonded fibrous veil, it does not have to be. Further, while the process as illustrated in FIG. 2 relates to the application of the surface finish formulation to only one face 14 of the veil 12, it should be appreciated that it may be applied to both, opposing faces. Thus, the veil 12 may be brought into the Foulard applicator to assure that the prebonded veil 12 is wetted on both sides. This may be done by bringing the veil into the applicator from above in a double roll system, wherein surface finish formulation is capable of coating both sides/faces of the veil. Subsequently, the impregnated veil 10 is dried and/or cured in an oven or other drying device.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. An impregnated fibrous veil, comprising:
a nonwoven fibrous veil including a prebinder and reinforcing fibers selected from a group consisting of glass fibers, ceramic fibers, synthetic fibers and mixtures thereof, said nonwoven fibrous veil having at least one face impregnated at a rate of between about 90.0 g/m² and about 200 g/m²
with a formulation including about 80 to about 98 weight percent filler, about 2 to about 20 weight percent binder and about 0 to about 1 weight percent optical brightener.

2. The impregnated fibrous veil of claim 1, further characterized by an air porosity of about 100 l/m²s to about 2,000 l/m²s at 1 m Bar pressure.

3. The impregnated fibrous veil of claim 2, wherein microspheres are substantially absent from said surface finish formulation.

4. The impregnated fibrous veil of claim 2, wherein said impregnated fibrous veil has a thickness of about 0.3 mm to about 0.7 mm at 0.5 kPa.

5. The impregnated fibrous veil of claim 3 wherein said nonwoven fibrous veil includes about 5 to about 20 weight percent prebinder and between about 80 to about 95 weight percent reinforcing fibers.

6. The impregnated fibrous veil of claim 1, wherein said prebinder includes bonding fibers.

7. The impregnated fibrous veil of claim 1, wherein said prebinder includes thermoplastic bonding fibers.

8. The impregnated fibrous veil of claim 4, wherein said prebinder includes bicomponent fibers.

9. The impregnated fibrous veil of claim 1 wherein said prebinder is selected from a group of materials consisting of a water soluble PVA powder or fiber.

10. The impregnated fibrous veil of claim 4 wherein said reinforcing fibers have a diameter between about 6.5 and about 16.0 microns and a length between about 4 and about 33 mm.

11. The impregnated fibrous veil of claim 10, wherein said filler is an inorganic filler that is dispersible in water.

12. The impregnated fibrous veil of claim 11, wherein said inorganic filler has an average particle size in the range of about 0.1 to about 50 microns.

13. The impregnated fibrous veil of claim 12, wherein said filler is selected from a group consisting of calcium carbonate, aluminum trihydrate, titanium dioxide, magnesium hydroxide, silicium oxide, clay, talc and mixtures thereof.

14. The impregnated fibrous veil of claim 13, wherein said binder includes both thermosetting and thermoplastic resins.

15. The impregnated fibrous veil of claim 13, wherein said binder is a water dispersible emulsion type binder or a solution type binder.

16. The impregnated fibrous veil of claim 13, wherein said binder is a combination of a solution type binder and an emulsion type binder provided at a ratio of between about 0.1 to 1 to about 10 to 1.

17. The impregnated fibrous veil of claim 13, wherein said binder is selected from a group of materials consisting of a water soluble binder, an emulsion binder, polymers and copolymers of styrene, butadiene, acrylic and methacrylic monomers, vinyl acetate, polyesters, polyvinyl alcohols, melamin formaldehyde resins, urea formaldehyde resins and mixtures thereof.

18. The impregnated fibrous veil of claim 13 wherein said binder includes polyvinyl alcohol and acrylic emulsion at a ratio of about 1 to 2.

19. The impregnated fibrous veil of claim 1 wherein said filler has a particle size distribution of about 0.1 to 10 micron with an average of 5 microns.

20. The impregnated fibrous veil of claim 1, wherein said fillers include recycled glass fibers or recycled glass veil.

21. A method of producing an impregnated fibrous veil with a smooth surface finish, comprising:
impregnating at least one face of a nonwoven fibrous veil including a prebinder and reinforcing fibers with a formulation including about 80 to about 98 weight percent filler, about 2 to about 20 weight percent binder and about 0 to about 1 weight percent optical brightener by applying said formulation to said at least one face of said nonwoven fibrous veil at an amount of between about 60 g/m² and about 200 g/m².

22. The method of claim 21, wherein said impregnating step includes feeding said nonwoven fibrous veil in-line during said applying step.

23. The method of claim 22, wherein said impregnating step was done using a size press and includes drying and consolidating said impregnated fibrous veil following said applying step.

24. The method of claim 21 further including producing a nonwoven fibrous veil and performing said impregnating step offline with said nonwoven fibrous veil production.
